(19) United States
(12) Patent Application Publication
(10) Pub. No.: US 2022/0300274 A1
(43) Pub. Date: Sep. 22, 2022

(54) PROGRAM UPDATE CONTROL APPARATUS, PROGRAM UPDATE CONTROL METHOD, AND COMPUTER-READABLE STORAGE MEDIUM

(71) Applicant: HONDA MOTOR CO.,LTD., Tokyo (JP)

(72) Inventors: Genta INOUE, Tokyo (JP); Yosuke SHIONOYA, Tokyo (JP)

(21) Appl. No.: 17/673,803

(22) Filed: Feb. 17, 2022

(30) Foreign Application Priority Data
Mar. 19, 2021 (JP) 2021-045915

(51) Int. Cl. G06F 8/654; H04L 43/0876

(52) U.S. Cl. CPC G06F 8/654; H04L 43/0876

(57) ABSTRACT

A program update control apparatus includes an obtaining unit configured to obtain a communication traffic volume on a first communication network to which a plurality of control units are connected, a rewrite control unit configured to transmit first rewrite data for performing rewrite of a program of a first control unit to the first control unit through the first communication network to perform control to rewrite the program of the first control unit, and a determination unit configured to determine, based on the communication traffic volume on the first communication network, a data volume of the first rewrite data per unit time which is transmitted by the rewrite control unit to the first control unit through the first communication network such that the communication traffic volume on the first communication network at a time when the rewrite control unit transmits the first rewrite data is to be a predetermined value.

The contents of the following Japanese patent application(s) are incorporated herein by reference: NO. 2021-045915 filed on Mar. 19, 2021.

### BACKGROUND

### 1. Technical Field

The present invention relates to a program update control apparatus, a program update control method, and a computer-readable storage medium.

### 2. Related Art

Patent document 1 discloses an ECU that can rewrite an application program as an ECU for vehicles.
Patent document 1: Japanese Unexamined Patent Application, Publication No. 2020-27666

### BRIEF DESCRIPTION OF THE DRAWINGS

FIG. 1 schematically illustrates an update system 10 according to one embodiment.

FIG. 2 schematically illustrates a system configuration included in a control system 200 together with devices to be controlled.

FIG. 3 schematically illustrates change over time of a communication traffic volume on one communication network 280 before and after an IG is turned off.

FIG. 4 is a diagram for describing a transmission condition of rewrite data to be transmitted to an ECU including a double bank memory.

FIG. 5 is a diagram for describing operations of an ECU that are related to program update.

FIG. 6 is a flow chart illustrating an execution procedure of transmission control processing to be executed by an ECU 202.

FIG. 7 illustrates an example of a computer 2000.

### DESCRIPTION OF EXEMPLARY EMBODIMENTS

Hereinafter, the present invention will be described by way of embodiments of the invention, but the following embodiments are not intended to restrict the invention according to the claims. In addition, not all combinations of features described in the embodiments necessarily have to be essential to solving means of the invention.

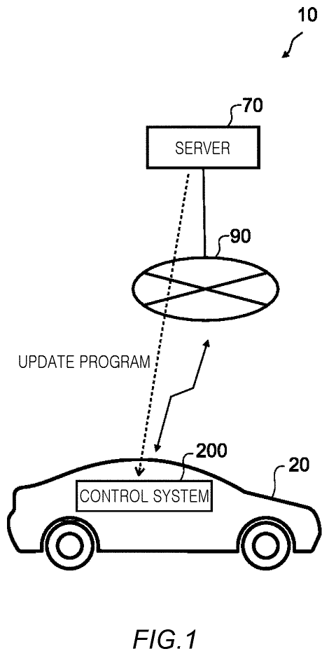

FIG. 1 schematically illustrates an update system 10 according to one embodiment. The update system 10 includes a vehicle 20 and an external apparatus 70. The vehicle 20 includes a control system 200. The control system 200 is responsible for control of the vehicle 20 and communication with the external apparatus 70 through a communication network 90. The communication network 90 includes an IP network such as the Internet, a P2P network, a dedicated circuit including a VPN, a virtual network, a mobile communication network, or the like.

In the vehicle 20, the control system 200 includes a plurality of electronic control units (ECUs) configured to perform control of the vehicle 20. The control system 200 obtains an update program of an ECU included in the control system 200 from the outside. For example, the control system 200 receives an update program transmitted from the external apparatus 70 through the communication network 90 by wireless communication. The control system 200 performs reprogramming of the ECU included in the control system 200 by rewriting a program to be executed by the ECU included in the control system 200 with an update program. Such reprogramming is performed for a purpose of upgrade or the like of a function of the ECU included in the control system 200. In this manner, the control system 200 updates the ECU by reprogramming the ECU over the air (OTA). According to the present embodiment, rewrite of a program to be executed by a device such as an ECU with an update program is referred to as “program update”.

At least a part of the program update of the ECU is executed after an IG switch is turned off. Since it is not possible for the vehicle 20 to travel while the program update of the ECU is executed when the IG is off, the program update is desirably completed in a short period of time. For this reason, it is necessary to increase a transmission speed of rewrite data of the program for the ECU. The rewrite data for the ECU is transmitted through a controller area network (CAN) in the vehicle 20. In the CAN, when communication traffic increases, a transmission error occurs, and retransmission control is performed. For this reason, when a large volume of rewrite data is transmitted, transmission efficiency may decrease. In view of the above, when the rewrite data is to be transmitted to the ECU, the control system 200 obtains a communication traffic volume on the CAN, and adjusts a transmission volume of the rewrite data per unit time such that the communication traffic volume does not exceed a threshold. For example, the transmission volume of the rewrite data per unit time is adjusted such that the communication traffic volume is to be at 80% of a maximum traffic volume. With this configuration, the program update can be completed in a shorter period of time than before.

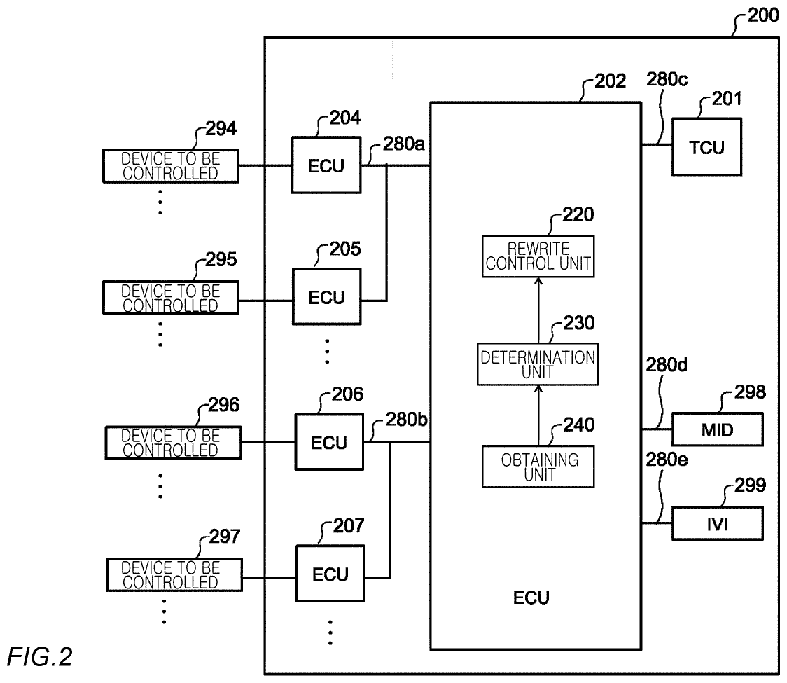

FIG. 2 schematically illustrates a system configuration included in the control system 200 together with devices to be controlled. The control system 200 includes a TCU 201, an ECU 202, an ECU 204, an ECU 205, an ECU 206, an ECU 207, an MID 298, and an IVI 299.

The ECU 202 mutually communicates with the TCU 201, the ECU 204, the ECU 205, the ECU 206, and the ECU 207 as well as the MID 298 and the IVI 299 through communication networks 280a to 280e (which may be collectively referred to as a communication network 280). The ECU 202 is configured to control the TCU 201, the ECU 204, the ECU 205, the ECU 206, and the ECU 207 as well as the MID 298 and the IVI 299 in an overall manner. The communication network 280 may be configured by including, for example, a CAN, an Ether network, or the like.

The TCU 201 is a telematics control unit. The TCU 201 is mainly responsible for mobile communication. The TCU 201 performs transmission and reception of data with the external apparatus 70 based on control of the ECU 202. The TCU 201 receives the update program transmitted from the external apparatus 70 by the mobile communication based on the control of the ECU 202. The TCU 201 may function as a wireless communication unit.

The MID 298 is a multi information display. The IVI 299 is, for example, an infotainment information device (IVI). The MID 298 and the IVI 299 may function as a display control unit. The IVI 299 includes a wireless LAN communication function. The IVI 299 receives the update program transmitted from the external apparatus 70 by wireless LAN communication based on the control of the ECU 202.

Each of the ECU 204, the ECU 205, the ECU 206, and the ECU 207 is an ECU as a vehicle control unit configured to control at least a part of the vehicle 20. The ECU 204, the ECU 205, the ECU 206, and the ECU 207 are one example of a “movable object control unit”. The ECU 204, the ECU 205, the ECU 206, and the ECU 207 are configured to control various devices to be controlled which are included in the vehicle 20. The devices to be controlled are, for example, a fuel injection apparatus, a battery, a locking apparatus, and the like. The ECU 204 controls a device 294 to be controlled, the ECU 205 controls a device 295 to be controlled, the ECU 206 controls a device 296 to be controlled, and the ECU 207 controls a device 297 to be controlled.

The ECU 202 is connected to the ECU 204 and the ECU 205 through the communication network 280a. The ECU 202, the ECU 204, and the ECU 205 are mutually communicable through the communication network 280a. In addition, the ECU 202 is connected to the ECU 206 and the ECU 207 through the communication network 280b. The ECU 202, the ECU 206, and the ECU 207 are mutually communicable through the communication network 280a.

According to the present embodiment, a system configuration is exemplified in which the control system 200 includes the TCU 201, the ECU 202, the ECU 204, the ECU 205, the ECU 206, the ECU 207, the MID 298, and the IVI 299, but the system configuration of the control system 200 is not limited to the example of the present embodiment. In addition, according to the present embodiment, for illustrative purposes, descriptions will be provided where a movable object control unit that may be set as a target of the program update corresponds to the ECU 204 and the ECU 205, and the ECU 202 functions as a “program update control apparatus” configured to control the program update. It should be noted that the movable object control unit that may be set as the target of the program update is not limited to these ECUs. The movable object control unit that may be set as the target of the program update may be any of the TCU 201, the ECU 202, the ECU 204, the ECU 205, the ECU 206, the ECU 207, the MID 298, and the IVI 299.

The ECU 202 functions as the program update control apparatus configured to control the program update of the ECU. The ECU 202 includes a rewrite control unit 220, a determination unit 230, and an obtaining unit 240. Here, a case where the ECU set as the program update target is the ECU 204 will be considered to describe an outline of processing of the obtaining unit 240, the rewrite control unit 220, and the determination unit 230.

The obtaining unit 240 is configured to obtain a communication traffic volume on the communication network 280a to which a plurality of ECUs configured to control at least a part of the vehicle 20 are connected. The rewrite control unit 220 is configured to perform control to rewrite a program of the ECU 204 by transmitting first rewrite data for performing rewrite of the program of the ECU 204 among the plurality of ECUs to the ECU 204 through the communication network 280a. The determination unit 230 is configured to determine a data volume of the first rewrite data per unit time which is transmitted by the rewrite control unit 220 to the ECU 204 through the communication network 280a such that, based on the communication traffic volume on the communication network 280a which is obtained by the obtaining unit 240, the communication traffic volume on the communication network 280a at a time when the rewrite control unit 220 transmits the first rewrite data is to be a predetermined value.

While the rewrite control unit 220 transmits the first rewrite data, the obtaining unit 240 repeatedly obtains the communication traffic volume on the communication network 280a. The determination unit 230 repeatedly determines, based on the communication traffic volume on the communication network 280a which is repeatedly obtained by the obtaining unit 240 while the rewrite control unit 220 transmits the first rewrite data, the data volume of the first rewrite data per unit time which is transmitted by the rewrite control unit 220 to the ECU 204 through the communication network 280a.

The determination unit 230 may determine a transmission cycle of the first rewrite data transmitted by the rewrite control unit 220 through the communication network 280a.

When the communication traffic volume on the communication network 280a decreases, the determination unit 230 may increase the data volume of the first rewrite data per unit time which is transmitted by the rewrite control unit 220 to the ECU 204 through the communication network 280a. When the communication traffic volume on the communication network 280a increases, the determination unit 230 may decrease the data volume of the first rewrite data per unit time which is transmitted by the rewrite control unit 220 to the ECU 204 through the communication network 280a.

When an ignition power source of the vehicle 20 is turned off, the obtaining unit 240 obtains the communication traffic volume on the communication network 280a to which the plurality of ECUs configured to control at least a part of the vehicle 20 are connected, the determination unit 230 determines the data volume of the first rewrite data per unit time which is transmitted by the rewrite control unit 220 to the ECU 204 through the communication network 280a, and the rewrite control unit 220 starts the control to rewrite the program of the ECU 204 by transmitting the first rewrite data to the ECU 204 through the communication network 280a.

A case will be described where the program update of the ECU 204 and the program update of the ECU 206 are controlled in parallel. In parallel with the obtainment of the communication traffic volume on the communication network 280a, the obtaining unit 240 may obtain a communication traffic volume on the communication network 280b to which the plurality of ECUs are connected. In parallel with the transmission of the rewrite data through the communication network 280a, the rewrite control unit 220 may perform control to rewrite a program of the ECU 206 by transmitting, to the ECU 206 through the communication network 280b, second rewrite data for performing rewrite of the program of the ECU 206 among the plurality of ECUs connected to the communication network 280b. The determination unit 230 may determine, in parallel with the determination of the data volume of the first rewrite data and based on the communication traffic volume on the communication network 280b obtained by the obtaining unit 240, a data volume of the second rewrite data per unit time which is transmitted by the rewrite control unit 220 to the ECU 206 through the communication network 280b such that the communication traffic volume on the communication network 280b is to be a predetermined value. With this configuration, it is possible to perform the program update of the ECUs in parallel which are connected to the different networks. With this configuration, a required time period of the program update can be shortened.

Here, the program update will be described. Program update processing in a case where a device set as a target of the program update is an ECU and a memory for firmware storage of the ECU is a single bank memory (so called one-side ROM) will be described. In this case, since there is a single program storage area for firmware storage of the ECU, an update program cannot be written to the program storage area when the ECU is operating according to the program stored in the program storage area. When the program update of the ECU is to be performed, the rewrite control unit 220 transfers the update program to the ECU to cause the update program to be stored in a predetermined data storage area of the ECU, and then instructs the ECU to perform the program update. When the program update is instructed, the ECU executes a control code for performing the program update to write the update program transferred to the data storage area to the program storage area, and activates the update program. The activation of the update program includes processing of setting a startup parameter of the ECU such that the update program is loaded to start control based on the update program at the time of startup of the ECU, for example.

Next, program update processing in a case where an internal memory of the ECU is a double bank memory (so called two-side ROM) will be described. In this case, since the ECU has two program storage areas for firmware storage, when the ECU is operating according to a program stored in a first program storage area, the update program can be written to a second program storage area. That is, by so called back surface write, the update program can be written to the second program storage area corresponding to a back surface. Accordingly, the update program can be written to the second program storage area even when, for example, the vehicle 20 is in motion. For this reason, when the update program is transferred to the ECU, the rewrite control unit 220 instructs the ECU to write the update program to the second program storage area. When the write of the update program to the second program storage area of the ECU is completed, a state is established in which the program update of the ECU can be performed. When the rewrite control unit 220 is to perform the program update of the ECU, the rewrite control unit 220 instructs the ECU to activate the update program written to the second program storage area. The activation of the update program includes processing of setting a startup parameter of the ECU such that the update program stored in the second program storage area is loaded to start control based on the update program at the time of startup of the ECU, for example. For example, the activation of the update program includes processing of enabling the second program storage area as a read area of the program and also disabling the first program storage area as the read area of the program. In this manner, the “program update” is a concept including issuing an instruction to write the update program to the program storage area of the ECU. In addition, the “program update” is a concept including issuing an instruction to activate the update program written to the program storage area. When the activation is completed, the existing program is rewritten with a new update program.

In the program update of the ECU having the internal memory of the single bank memory, it may not be possible for the ECU to control the vehicle over a period in which the update program is written to the program storage area and a period in which the update program is activated. On the other hand, in the program update of the ECU having the internal memory of the double bank memory, over a period in which the update program is written to the program storage area of the back surface (non-active surface), the ECU can perform the control of the vehicle according to the program stored on the other surface (active surface).

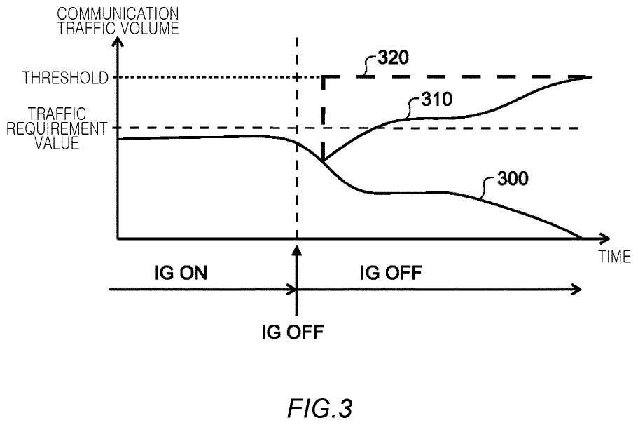

FIG. 3 schematically illustrates change over time of the communication traffic volume on one communication network 280 before and after the IG is turned off.

Reference numeral 300 denotes a communication traffic volume generated between ECUs other than the communication of the rewrite data of the program. When the IG switch is on, a communication volume of each of the ECUs is set to be lower than or equal to a predetermined traffic requirement value. As illustrated with reference numeral 300, the communication occurs between the ECUs through the communication network 280 over a certain period of time even after the IG switch is turned off. Therefore, when a large volume of rewrite data is transmitted to the communication network 280 immediately after the IG switch is turned off, the traffic approaches 100%, and retransmission control occurs, so that transmission efficiency may decrease.

Reference numeral 310 denotes change over time of the communication traffic volume related to the program update which is transmitted by the ECU 202 after the IG is turned off. The program update executed after the IG is turned off includes processing of transmitting the data of the update program for the ECU to the ECU, processing of executing the write to the program storage area included in the ECU and the activation, and the like. The “rewrite data” to be transmitted to the ECU includes program data that is the update program itself, control data for instructing the write to the program storage area, control data for instructing the execution of the activation, and the like. It should be noted that the transmission of the rewrite data for the ECU including the single bank memory is performed while the IG is off. The transmission of the rewrite data for the ECU including the double bank memory can be performed while the IG is on, but may also be performed while the IG is off.

Reference numeral 320 denotes a total value of the communication traffic other than the rewrite data (reference numeral 300) and the communication traffic volume of the rewrite data transmitted by the ECU 202 after the IG is turned off (reference numeral 310). When the IG switch is turned off, the determination unit 230 measures a communication traffic volume on the communication network 280, and determines a data volume per unit time of the rewrite data transmitted to the ECU through the communication network 280 based on the measured communication traffic volume such that an entire communication traffic volume (reference numeral 320) on the communication network 280 is matched with a predetermined threshold. For example, the determination unit 230 determines a transmission cycle of a data frame of the rewrite data to be transmitted through the communication network 280. The rewrite control unit 220 transmits the data frame of the rewrite data according to the transmission cycle determined by the determination unit 230.

After that, the communication traffic volume on the communication network 280 is periodically obtained, and when the communication traffic volume denoted by reference numeral 300 decreases, the determination unit 230 increases the data volume of the rewrite data transmitted per unit time, and when the communication traffic volume denoted by reference numeral 300 increases, the determination unit 230 decreases the data volume of the rewrite data transmitted per unit time. Therefore, as illustrated with reference numeral 320, it is possible to perform the control such that the entire traffic volume on the communication network 280 is to be constant in the vicinity of the threshold. It should be noted that the threshold may be a value that is 80% of a maximum traffic volume in the communication network 280. With this configuration, while the retransmission control is smoothly executed even in a case where a retransmission instruction occurs, that is, the ECU 202 requests another ECU to retransmit the information, since there is a buffer of 20%, it is possible to transmit the information to the ECU using the buffer. In other words, a combination of the threshold with the buffer (area for the retransmission control) is preferably set at the maximum value (100%) of the communication traffic. The threshold may be set for each of the communication networks 280. The threshold may be set for each type of the communication networks 280. For example, the threshold may be set for each of the types of the CANs such as FCAN and CAN-FD.

The control described in association with FIG. 3 allows decreasing the frequency of occurrence of the retransmission control in the communication network 280 while increasing the transmission speed of the rewrite data in an allowable range. Therefore, the required time period of the program update can be shortened. It should be noted that the rewrite control unit 220 executes the control described in association with FIG. 3 in each of the communication network 280a and the communication network 280b. This configuration allows, for example, progressing the program update of the ECU 204 and the program update of the ECU 206 in parallel when both of the program updates are required to be performed. This can reduce an increase in the required time period of the program update. The data volume of the rewrite data transmitted per unit time is adjusted according to the communication traffic volume of each of the communication network 280a and the communication network 280b, which may, in addition, be able to reduce excessive processing load to be applied on the ECU 202 with regard to generation and transmission of the rewrite data.

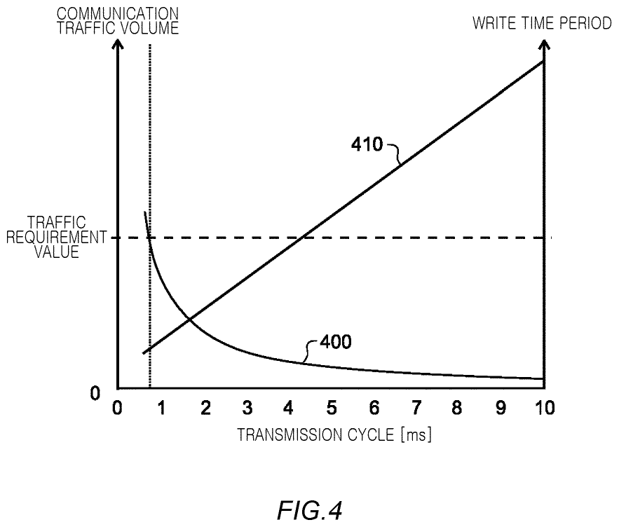

FIG. 4 is a diagram for describing a transmission condition of the rewrite data transmitted to the ECU including the double bank memory. The rewrite data can be transmitted to the ECU including the double bank memory while the IG is on. While the IG is on, with regard to communication other than the transmission of the rewrite data related to the program update, a communication traffic volume is set to be lower than or equal to a traffic requirement value. For this reason, with regard to the transmission of the rewrite data while the IG is on, it is necessary to set the communication traffic volume related to the rewrite data to be lower than or equal to “100%−the traffic requirement value”.

In the present embodiment, a data size of the data frame of the rewrite data is fixed. The data volume per unit time at which the rewrite data is transmitted is set using the transmission cycle of the data frame, for example. Reference numeral 400 in FIG. 4 denotes how the communication traffic volume of the rewrite data changes when the transmission cycle of the data frame is changed. As illustrated with reference numeral 400, it is understood that the communication traffic volume is above the traffic requirement value when the transmission cycle is set to 0.5 ms and is below the traffic requirement value when the transmission cycle is set to 1 ms. Reference numeral 410 denotes how a time period for writing the update program to the program storage area changes when the transmission cycle of the data frame is changed. As illustrated with reference numeral 410, it is understood that the write time period is shortened as the transmission cycle is shortened. The data illustrated in FIG. 4 shows that setting the transmission cycle of the data frame to 1 ms allows reducing the write time period while satisfying the requirements for the communication traffic volume. It should be noted that a transmission condition of the rewrite data while the IG is on may be set for each of the communication networks 280. The transmission condition of the rewrite data while the IG is on may be set for each of the types of the communication networks 280. For example, the transmission condition of the rewrite data while the IG is on may be set for each of the types of the CANs such as FCAN and CAN-FD.

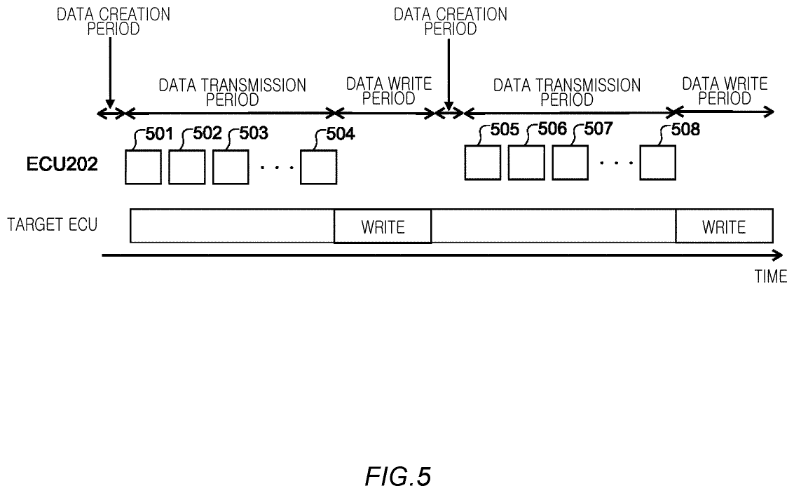

FIG. 5 is a diagram for describing operations of an ECU that are related to the program update. A “target ECU” of FIG. 5 is an ECU set as a target of the program update. In the ECU 202, a “data creation period” is a period in which the ECU 202 generates rewrite data. A “data transmission period” is a period in which the rewrite control unit 220 transmits data frames 501 to 508 of the rewrite data to the target ECU through the communication network 280. A “data write period” is a period in which the data of the update program received by the target ECU is written to the program storage area. As illustrated in FIG. 5, the program update by the ECU 202 and the target ECU is performed by mainly repeating respective processes in the data creation period, the data transmission period, and the data write period.

It should be noted that according to the present embodiment, the data size of the data frame of the rewrite data is fixed, and the communication traffic volume is adjusted by the transmission cycle of the data frame of the rewrite data. Since the data size of the data frame is fixed, change of the transmission cycle of the data frame is synonymous with change of a transmission interval of the continuous data frames.

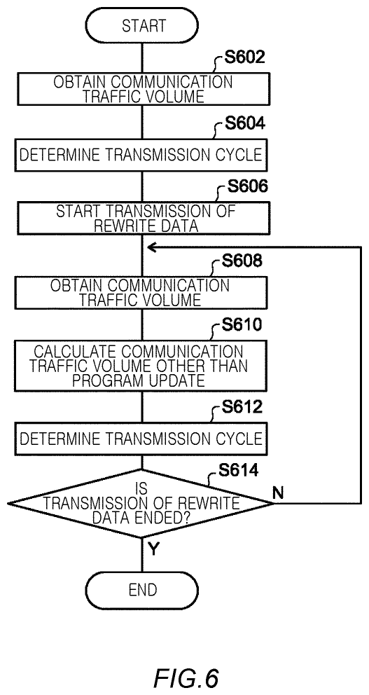

FIG. 6 is a flow chart illustrating an execution procedure of transmission control processing executed by the ECU 202. The processing of the flow chart of FIG. 6 is started when the IG power source is turned off.

In S602, the obtaining unit 240 obtains the communication traffic volume on the communication network 280. In S604, the determination unit 230 determines the transmission cycle of the data frame of the rewrite data based on the communication traffic volume on the communication network 280 which is obtained in S602. For example, as described in association with FIG. 3 or the like, the transmission cycle of the data frame of the rewrite data is determined such that a total value of the communication traffic volume predicted to be generated when the data frame of the rewrite data is transmitted and the communication traffic volume on the communication network 280 obtained in S602 is to be a predetermined threshold.

In S606, the rewrite control unit 220 starts the transmission of the data frame of the rewrite data at the transmission cycle determined by the determination unit 230 in S604. In S608, the obtaining unit 240 obtains the communication traffic volume on the communication network 280 again. In S610, the determination unit 230 calculates the communication traffic volume related to the communication other than the program update. For example, the determination unit 230 calculates the communication traffic volume related to the communication other than the program update by subtracting the communication traffic volume which increases when the data frame is transmitted at the transmission cycle determined in S604 from the communication traffic volume obtained in S608. In S612, the determination unit 230 determines again the transmission cycle of the data frame of the rewrite data based on the communication traffic volume related to the communication other than the program update which is calculated in S610. For example, as described in association with FIG. 3 or the like, the transmission cycle of the data frame of the rewrite data is determined such that the total value of the communication traffic volume predicted to be generated when the data frame of the rewrite data is transmitted and the communication traffic volume calculated in S610 is to be a predetermined threshold.

In S614, the rewrite control unit 220 determines whether to end the transmission of the rewrite data. For example, when all the transmission of the rewrite data is completed, it is determined to end the transmission of the rewrite data. When it is determined to end the transmission of the rewrite data, the processing of this flow chart is to be ended. When it is determined not to end the transmission of the rewrite data, the processing shifts to S608, and the processing in S608 to S612 is repeated. With this configuration, the rewrite data can be transmitted in a short period of time to the ECU set as the program update target. Consequently, the required time period of the program update processing after the IG is turned off can be reduced.

It should be noted that as described in association with FIG. 3 or the like, the processing described in association with FIG. 6 is performed for each of the plurality of communication networks 280. For this reason, respective processes in S602 to S614 may be executed in parallel in the plurality of communication networks 280.

The vehicle 20 is a vehicle as one example of the transport device. The vehicle may be a motor vehicle such as a motor vehicle including an internal combustion engine, an electric motor vehicle, or a fuel cell motor vehicle (FCV). The motor vehicle includes a bus, a truck, a two-wheeled motor vehicle, or the like. The vehicle may be a saddle type vehicle or the like, or may be a motorbike. Examples of the transport device include devices such as an aircraft including an unmanned aircraft and a vessel in addition to the vehicle. The transport device may be any device configured to transport a person or an article. The transport device is one example of the movable object. The movable object is not limited to the transport device, and may be any movable device.

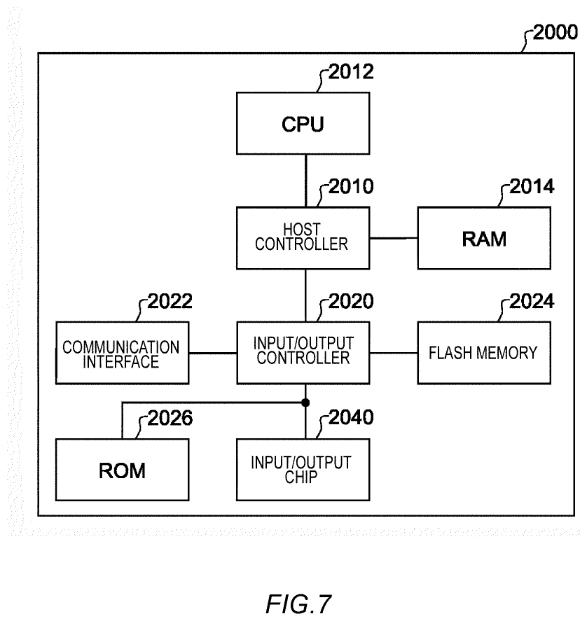

FIG. 7 illustrates an example of a computer 2000 where a plurality of embodiments of the present invention may be entirely or partially embodied. A program installed on the computer 2000 can cause the computer 2000 to function as a system such as the control system or each unit of the system according to the embodiments or an apparatus such as the information processing apparatus or each unit of the apparatus, to perform operations associated with the system or each unit of the system or the apparatus or each unit of the apparatus, and/or to perform the process according to the embodiments or steps of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to the programs stored in the ROM 2026 and the RAM 2014, thereby controlling each unit.

The communication interface 2022 communicates with other electronic devices via a network. The flash memory 2024 stores programs and data used by the CPU 2012 in the computer 2000. The ROM 2026 stores a boot program or the like that is executed by the computer 2000 during activation, and/or a program that depends on hardware of the computer 2000. In addition, the input/output chip 2040 may connect various input/output units such as a keyboard, a mouse, and a monitor to the input/output controller 2020 via an input/output port such as a serial port, a parallel port, a keyboard port, a mouse port, a monitor port, a USB port, an HDMI (registered trademark) port.

A program is provided via a computer-readable storage medium such as a CD-ROM, a DVD-ROM, or a memory card, or a network. The RAM 2014, the ROM 2026, or the flash memory 2024 is an example of the computer-readable storage medium. The program is installed in the flash memory 2024, the RAM 2014, or the ROM 2026, and is executed by the CPU 2012. Information processing written in these programs is read by the computer 2000, resulting in cooperation between a program and the above mentioned various types of hardware resources. An apparatus or a method may be configured by implementing operations or processing of information according to a use of the computer 2000.

For example, when communication is performed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 to be read into the RAM 2014, and perform various types of processing on the data on the RAM 2014. The CPU 2012 then writes back the processed data into the recording medium.

Various types of information such as various types of programs, data, a table, and a database may be stored in the recording medium and may be subjected to information processing. The CPU 2012 may execute, on the data read from the RAM 2014, various types of processing including various types of operations, information processing, conditional judgement, conditional branching, unconditional branching, information retrieval and replacement, or the like described herein and specified by instruction sequences of the programs, and write back a result into the RAM 2014. In addition, the CPU 2012 may search for information in a file, a database, or the like in the recording medium. For example, when a plurality of entries, each having an attribute value of a first attribute associated with an attribute value of a second attribute, is stored in the recording medium, the CPU 2012 may search for an entry having a designated attribute value of the first attribute that matches a condition from the plurality of entries, and read the attribute value of the second attribute stored in the entry, thereby obtaining the attribute value of the second attribute associated with the first attribute that satisfies a predetermined condition.

A program or a software module described above may be stored in a computer-readable storage medium on the computer 2000 or in proximity to the computer 2000. A recording medium such as a hard disk or a RAM provided in a server system connected to a dedicated communication network or the Internet can be used as a computer-readable storage medium. The program stored in the computer-readable storage medium may be provided to the computer 2000 via the network.

The program installed on the computer 2000 and causes the computer 2000 to function as the control system 200 may work on the CPU 2012 or the like to cause the computer 2000 to function as each unit of the control system 200, respectively. Information processing written in these programs is read by the computer 2000, thereby functioning as each unit of the control system 200 which is specific means in which a software and various hardware resources described above cooperate with each other. By implementing operations or processing of information according to the intended use of the computer 2000 in the present embodiment using these specific means, a control system 200 specific to the intended use is constructed.

Various embodiments have been described with reference to the block diagrams and the like. In the block diagrams, each block may represent (1) a step of a process in which an operation is executed, or (2) each unit of the apparatus having a role in executing the operation. Specific steps and each unit may be implemented by a dedicated circuit, a programmable circuit supplied along with a computer-readable instruction stored on a computer-readable storage medium, and/or a processor supplied along with the computer-readable instruction stored on the computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and other logical operations, and a memory element such as a flip-flop, a register, a field programmable gate array (FPGA), a programmable logic array (PLA), or the like.

The computer-readable storage medium may include any tangible device capable of storing an instruction executed by an appropriate device. As a result, the computer-readable storage medium having the instruction stored thereon constitutes at least a part of a product including an instruction that may be executed in order to provide a means to execute an operation specified by a processing procedure or a block diagram. Examples of computer-readable storage media may include an electronic storage medium, a magnetic storage medium, an optical storage medium, an electromagnetic storage medium, a semiconductor storage medium, etc. More specific examples of the computer-readable storage medium may include a floppy (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like; and a conventional procedural programming language such as a “C” programming language or a similar programming language.

Computer-readable instructions may be provided to a processor of a general purpose computer, a special purpose computer, or other programmable data processing apparatus, or to programmable circuit, locally or via a local area network (LAN), wide area network (WAN) such as the Internet, and a computer-readable instruction may be executed to provide means for performing operations specified in the described processing procedures or block diagrams. Examples of the processor include a computer processor, a processing unit, a microprocessor, a digital signal processor, a controller, a microcontroller, and the like.

While the embodiments of the present invention have been described, the technical scope of the present invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: update system
20: vehicle
70: external apparatus
90: communication network
200: control system
201: TCU
202: ECU
204: ECU
205: ECU
206: ECU
207: ECU
220: rewrite control unit
230: determination unit
240: obtaining unit
280: communication network
294, 295, 296, 297: device to be controlled
298: MID
299: IVI
2000: computer
2010: host controller
2012: CPU
2014: RAM
2020: input/output controller
2022: communication interface
2024: flash memory
2026: ROM
2040: input/output chip

What is claimed is:

1. A program update control apparatus comprising:
an obtaining unit configured to obtain a communication traffic volume on a first communication network to which a plurality of control units configured to control at least a part of an apparatus are connected;
a rewrite control unit configured to transmit first rewrite data for performing rewrite of a program of a first control unit among the plurality of control units to the first control unit through the first communication network to perform control to rewrite the program of the first control unit; and
a determination unit configured to determine, based on the communication traffic volume on the first communication network obtained by the obtaining unit, a data volume of the first rewrite data per unit time which is transmitted by the rewrite control unit to the first control unit through the first communication network such that the communication traffic volume on the first communication network at a time when the rewrite control unit transmits the first rewrite data is to be a predetermined value.

2. The program update control apparatus according to claim 1, wherein
the obtaining unit is configured to repeatedly obtain the communication traffic volume on the first communication network while the rewrite control unit transmits the first rewrite data, and
the determination unit is configured to repeatedly determine, based on the communication traffic volume on the first communication network repeatedly obtained by the obtaining unit while the rewrite control unit transmits the first rewrite data, the data volume of the first rewrite data per unit time which is transmitted by the rewrite control unit to the first control unit through the first communication network.

3. The program update control apparatus according to claim 1, wherein
the determination unit is configured to determine a transmission cycle of the first rewrite data transmitted by the rewrite control unit through the first communication network.

4. The program update control apparatus according to claim 1, wherein
the obtaining unit is configured to obtain, in parallel with the obtainment of the communication traffic volume on the first communication network, a communication traffic volume on a second communication network to which a plurality of control units are connected,
the rewrite control unit is configured to transmit, in parallel with the transmission of the first rewrite data through the first communication network, second rewrite data for performing rewrite of a program of a second control unit among the plurality of control units connected to the second communication network to the second control unit through the second communication network to perform control to rewrite the program of the second control unit, and
the determination unit is configured to determine, in parallel with the determination of the data volume of the first rewrite data and based on the communication traffic volume on the second communication network obtained by the obtaining unit, a data volume of the second rewrite data per unit time which is transmitted by the rewrite control unit to the second control unit through the second communication network such that the communication traffic volume on the second communication network is to be a predetermined value.

5. The program update control apparatus according to claim 2, wherein
when the communication traffic volume on the first communication network decreases, the determination unit is configured to increase the data volume of the first rewrite data per unit time which is transmitted by the rewrite control unit to the first control unit through the first communication network.

6. The program update control apparatus according to claim 2, wherein
when the communication traffic volume on the first communication network increases, the determination unit is configured to decrease the data volume of the first rewrite data per unit time which is transmitted by the rewrite control unit to the first control unit through the first communication network.

7. The program update control apparatus according to claim 1, wherein
the apparatus is a movable object, and the first communication network is a communication network in the movable object.

8. The program update control apparatus according to claim 7, wherein
the movable object is a vehicle.

9. The program update control apparatus according to claim 8, wherein
the first communication network is an in-vehicle communication network.

10. The program update control apparatus according to claim 8, wherein
the first communication network is a controller area network (CAN).

11. The program update control apparatus according to claim 8, wherein
when an ignition power source of the vehicle is turned off, the obtaining unit is configured to obtain the communication traffic volume on the first communication network to which the plurality of control units configured to control at least a part of the vehicle are connected, the determination unit is configured to determine the data volume of the first rewrite data per unit time which is transmitted by the rewrite control unit to the first control unit through the first communication network, and the rewrite control unit is configured to transmit the first rewrite data to the first control unit through the first communication network to start the control to rewrite the program of the first control unit.

12. The program update control apparatus according to claim 2, wherein
the determination unit is configured to determine a transmission cycle of the first rewrite data transmitted by the rewrite control unit through the first communication network.

13. The program update control apparatus according to claim 2, wherein
the obtaining unit is configured to obtain, in parallel with the obtainment of the communication traffic volume on the first communication network, a communication traffic volume on a second communication network to which a plurality of control units are connected,
the rewrite control unit is configured to transmit, in parallel with the transmission of the first rewrite data through the first communication network, second rewrite data for performing rewrite of a program of a second control unit among the plurality of control units connected to the second communication network to the second control unit through the second communication network to perform control to rewrite the program of the second control unit, and
the determination unit is configured to determine, in parallel with the determination of the data volume of the first rewrite data and based on the communication traffic volume on the second communication network obtained by the obtaining unit, a data volume of the second rewrite data per unit time which is transmitted by the rewrite control unit to the second control unit through the second communication network such that the communication traffic volume on the second communication network is to be a predetermined value.

14. The program update control apparatus according to claim 3, wherein
the obtaining unit is configured to obtain, in parallel with the obtainment of the communication traffic volume on the first communication network, a communication traffic volume on a second communication network to which a plurality of control units are connected,
the rewrite control unit is configured to transmit, in parallel with the transmission of the first rewrite data through the first communication network, second rewrite data for performing rewrite of a program of a second control unit among the plurality of control units connected to the second communication network to the second control unit through the second communication network to perform control to rewrite the program of the second control unit, and
the determination unit is configured to determine, in parallel with the determination of the data volume of the first rewrite data and based on the communication traffic volume on the second communication network obtained by the obtaining unit, a data volume of the second rewrite data per unit time which is transmitted by the rewrite control unit to the second control unit through the second communication network such that the communication traffic volume on the second communication network is to be a predetermined value.

15. The program update control apparatus according to claim 5, wherein
when the communication traffic volume on the first communication network increases, the determination unit is configured to decrease the data volume of the first rewrite data per unit time which is transmitted by the rewrite control unit to the first control unit through the first communication network.

16. The program update control apparatus according to claim 2, wherein
the apparatus is a movable object, and the first communication network is a communication network in the movable object.

17. The program update control apparatus according to claim 3, wherein
the apparatus is a movable object, and the first communication network is a communication network in the movable object.

18. A movable object comprising the program update control apparatus according to claim 1.

19. A program update control method comprising:
obtaining a communication traffic volume on a first communication network to which a plurality of control units configured to control at least a part of an apparatus are connected;
transmitting first rewrite data for performing rewrite of a program of a first control unit among the plurality of control units to the first control unit through the first communication network to perform control to rewrite the program of the first control unit; and
determining, based on the obtained communication traffic volume on the first communication network, a data volume of the first rewrite data per unit time which is transmitted to the first control unit through the first communication network such that the communication traffic volume on the first communication network at a time when the first rewrite data is transmitted is to be a predetermined value.

20. A non-transitory computer-readable storage medium having stored thereon a program, the program causing a computer to perform operations comprising:
obtaining a communication traffic volume on a first communication network to which a plurality of control units configured to control at least a part of an apparatus are connected;
transmitting first rewrite data for performing rewrite of a program of a first control unit among the plurality of control units to the first control unit through the first communication network to perform control to rewrite the program of the first control unit; and
determining, based on the obtained communication traffic volume on the first communication network, a data volume of the first rewrite data per unit time which is transmitted to the first control unit through the first communication network such that the communication traffic volume on the first communication network at a time when the first rewrite data is transmitted is to be a predetermined value.
